(19) United States
(12) Patent Application Publication
(10) Pub. No.: US 2011/0194886 A1
(43) Pub. Date: Aug. 11, 2011

(54) CORNER JOINT OF A FRAME FOR FIXING A SOLAR PANEL

(75) Inventors: I-TSUNG WU, Bali Shiang (TW); Ming-Chang Chiang, Bali Shiang (TW); Yaw-Der Wang, Gueishan Township (TW); Chuang-Chun Chueh, Gueishan Township (TW)

(73) Assignee: DE POAN PNEUMATIC CORP.

(21) Appl. No.: 12/831,626

(22) Filed: Jul. 7, 2010

(30) Foreign Application Priority Data
Feb. 10, 2010 (TW) 099202782

(51) Int. Cl. F16B 7/20

(52) U.S. Cl. 403/23

(57) ABSTRACT

A corner joint of a frame for fixing a solar panel disposed between two adjacent frame pieces of the frame includes an L shaped member and a sheath. Two ends of the L shaped member separately extend to one corresponding frame piece of the two adjacent frame pieces to form an extending arm plugged into a latching slot defined in an end of the corresponding frame piece. The L shaped member further includes a bending portion defining a mortise extending to the extending arm. The sheath includes two adjacent joint surfaces for abutting the two adjacent frame pieces. The sheath defines an upper receiving space and a lower receiving space therein. The upper receiving space and the lower receiving space are separately exposed from the joint surfaces. The upper receiving space and the lower receiving space are configured for receiving a corner of the solar panel and the bending portion, respectively. The sheath further includes a tenon capable of being plugged into the mortise and received in the latching slot such that the sheath joins the L shaped member and the solar panel. The corner joint can be easily molded and the manufacturing cost thereof is low.

### BACKGROUND

1. Technical Field

The present invention relates to a solar panel, and more particularly to a corner joint of a frame for fixing a solar panel.

2. Related Art

A solar cell generally includes a photovoltaic semiconductor chip which is capable of immediately generating electric power when irradiated under the sunlight. Solar cells can be assembled into a unitary module, for example, a solar panel, by vacuum packaging. A solar panel array can be obtained by assembling solar panels with frames. A solar panel array, a recharging and discharging protecting controller, a rechargeable battery, and an inverter can constitute a solar power supply system.

Usually, a frame used to assemble a solar panel consists of several frame pieces. Generally, solar panel is rectangular, and thus the frame pieces are also arranged in a rectangular distribution. Conventionally, at a corner of the frame, adjacent two frame pieces are jointed with an L shaped corner joint. For example, as disclosed in Taiwan issued patent M293419 and M318040, each of the frame pieces defines a slot for receiving an edge portion of a solar panel and two latching slots respectively at two opposite ends thereof for receiving and latching an end of the L shaped corner joint. An L shaped corner joint is arranged at each of the corners of the frame, and two legs of the L shaped corner joint are respectively received and latched in the latching slots of corresponding two adjacent frame pieces. As such, the frame pieces are united together to constitute the frame. In addition, to mask the L shaped corner joint, two opposite ends of the frame pieces are cut to form 45° joint surfaces. However, in above frames, the 45° angular joint are exposed.

Furthermore, Taiwan issued patent M362383 also discloses an improved corner joint which further includes an arc column extending from a corner of the L shaped corner joint. The arc column has two adjacent end surfaces for respectively abutting one of two perpendicularly arranged adjacent frame pieces, and thus the corner joint is exposed between the two adjacent frame pieces. In addition, the arc column defines a receiving space for receiving a corner of a solar panel. As such, the joint ends of the frame pieces are protected by the arc column and the appearance of the frame, the convenience of assembling are also improved.

### BRIEF SUMMARY

The present invention relates to a corner joint of a frame for fixing a solar panel, which is capable of solving the following problems:

1. In the corner joint having no arc column formed, sharp angular joint will be exposed after assembling. Thus, it is unsafe to use the obtained frame and the appearance is also need to be improved.

2. The structure of the corner joint having arc column is complex and thus the molding ability is low and the manufacturing cost is high.

To solve above problems, the present invention provides a corner joint of a frame for fixing a solar panel. The frame includes several adjacent frame pieces, and the corner joint is disposed between the two adjacent frame pieces.

The corner joint includes an L shaped member and a sheath. Two ends of the L shaped member separately extend to one corresponding frame piece of the two adjacent frame pieces to form an extending arm plugged into a latching slot defined in an end of the corresponding frame piece. The L shaped member further includes a bending portion defining a mortise extending to the extending arm. The sheath includes two adjacent joint surfaces for abutting the two adjacent frame pieces. The sheath defines an upper receiving space and a lower receiving space therein. The upper receiving space and the lower receiving space are separately exposed from the joint surfaces. The upper receiving space and the lower receiving space are configured for receiving a corner of the solar panel and the bending portion, respectively. The sheath further includes a tenon capable of being plugged into the mortise and received in the latching slot such that the sheath joins the L shaped member and the solar panel.

As such, the sheath of the present corner joint can be exposed between the two adjacent frame pieces to protective the joint of the two adjacent frame pieces. The sheath also improves aesthetic effect of the frame. In addition, it is more easily to assemble the frame. The sheath and the L shaped member can be separately molded thereby reducing the manufacturing complexity thereof. Therefore, the manufacturing cost of the present corner joint is low. Furthermore, the tenon is latched between an outer side of the L shaped member and the two adjacent frame pieces thereby improving the assembling fastness of the sheath, the L shaped member, the frame pieces and the solar panel.

Besides, the sheath is comprised of plastic or metals, the sheath is rectangular, and the sheath comprises an outer fillet surface symmetrical relative to an angle bisector surface of the two adjacent joint surfaces. The two adjacent joint surfaces are perpendicular to each other. A latching protrusion is formed on a top or bottom portion of an inner wall of the lower receiving space for latching the bending portion. The tenon defines a notch at a joint of the two adjacent frame pieces.

Other aspects, details, and advantages of the present corner joint are further described accompanying with preferred embodiments and figures as follows.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded view of a corner joint of a frame for fixing a solar panel in accordance with an embodiment of the present invention.

FIG. 2 is an isometric view of a sheath of the corner joint of FIG. 1.

FIG. 3 is a front view of the sheath of the corner joint of FIG. 1.

FIG. 4 is a top view of FIG. 3

FIG. 5 is a top view of the corner joint of FIG. 1.

FIG. 6 is a front view of the corner joint of FIG. 1.

FIG. 7 is a cross sectional view taken along the line A-A in FIG. 5.

FIG. 8 is a cross sectional view taken along the line B-B in FIG. 6.

FIG. 9 is a cross sectional view taken along the line C-C in FIG. 8.

FIG. 10 is a cross sectional view taken along the line D-D in FIG. 8.

FIG. 11 is a schematic view illustrating an operation state of the corner joint of FIG. 1

FIG. 12 is a top view of an L shaped member of the corner joint of FIG. 1

FIG. 13 is a cross sectional view taken along the line E-E in FIG. 12.

FIG. 14 is a schematic view illustrating another operation state of the corner joint of FIG. 1

FIG. 15 is a top view of the corner joint and frame pieces of FIG. 14.

FIG. 16 is a cross sectional view taken along the line F-F of FIG. 15.

### DETAILED DESCRIPTION

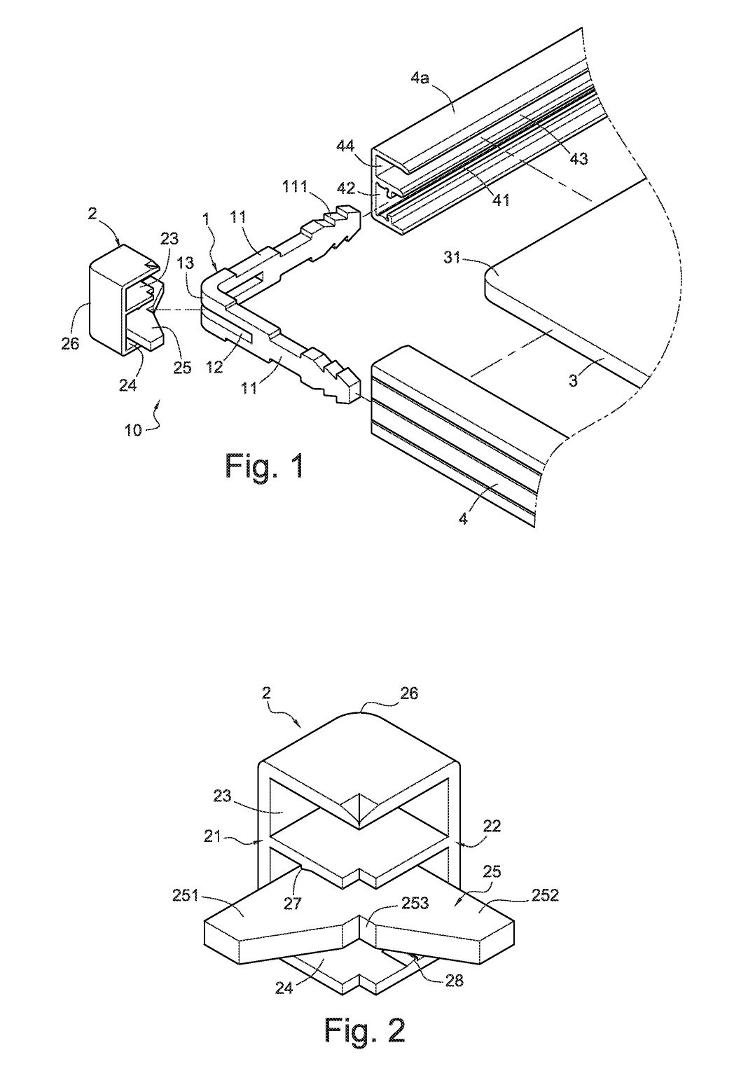

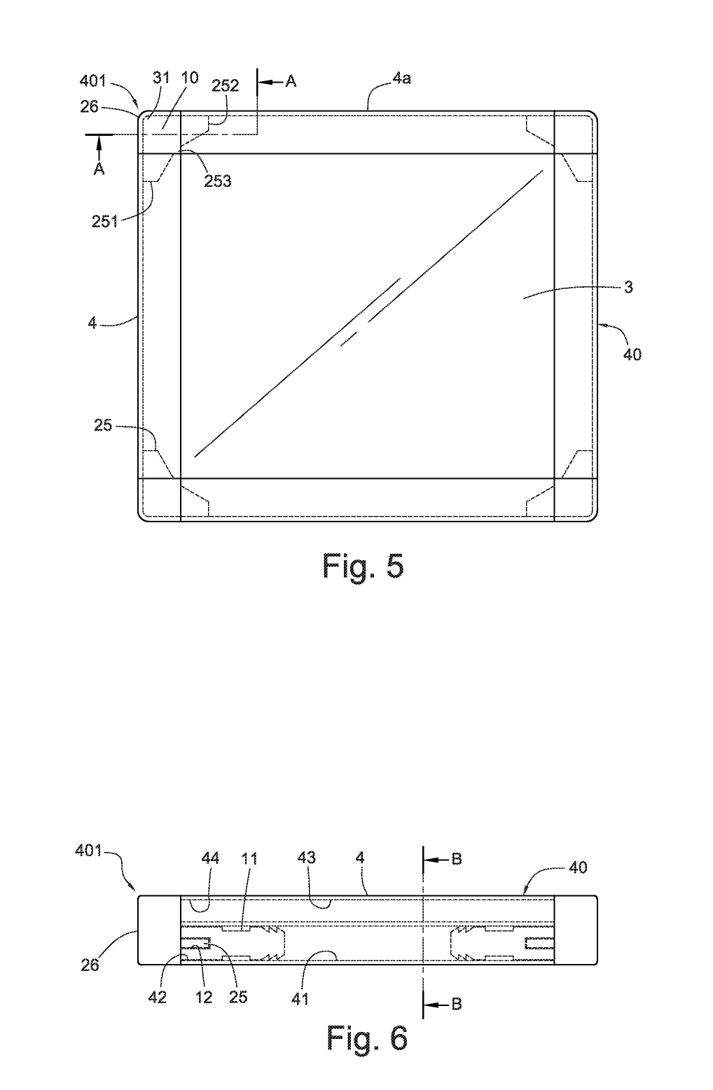

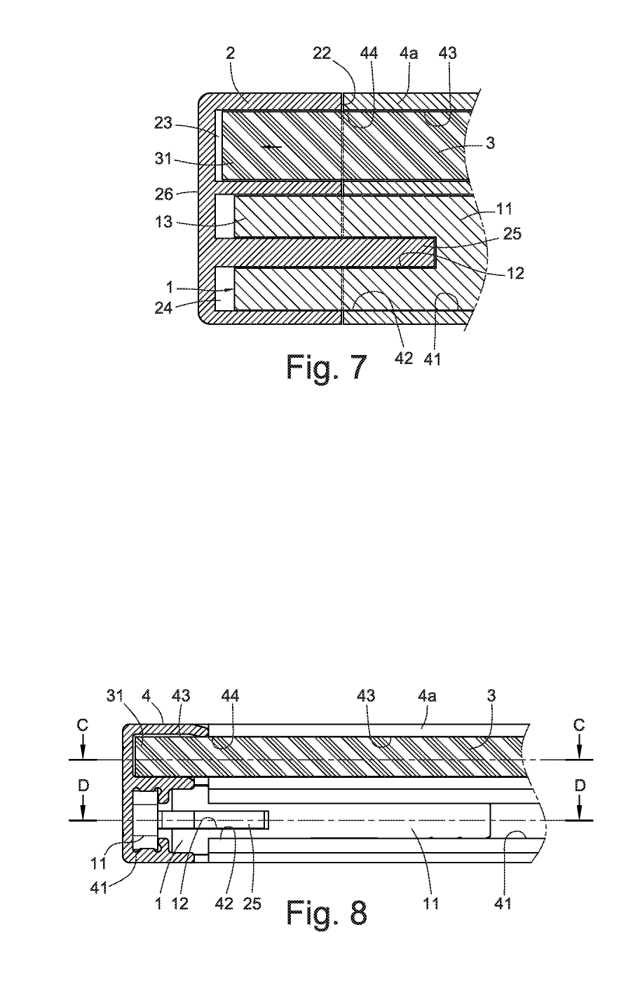

FIG. 1 is an exploded view of a corner joint 10 of a frame for fixing a solar panel in accordance with an embodiment of the present invention. Further referring to FIG. 5, the corner joint 10 is disposed between two adjacent frame pieces 4, 4a at a corner 401 of a frame 40. The corner joint 10 includes an L shaped member 1 and a sheath 2. The frame pieces 4, 4a are comprised of metals (for example, aluminum, iron, or copper), and are arranged along sides of a rectangular solar panel 3. In other words, the frame 40 is also rectangular. The frame piece 4, 4a respectively define a lower passage 41 and an upper slot 43 in the surface thereof that abuts a periphery of the solar panel 3. The lower passage 41 and the upper slot 43 are parallel to each other. The upper slot 43 is configured for receiving a periphery portion of the solar panel 3. The lower passage 41 runs through the frame pieces 4, 4a from an end surface thereof to another opposite end surface thereby defining a latching slot 42 at each of the two end surfaces of the frame pieces 4, 4a. The upper slot 43 also runs through the frame pieces 4, 4a from the end surface thereof to another opposite end surface thereby defining an opening 44 at each of the two end surfaces. Referring to FIGS. 6, 8, and 10, two ends of the L shaped member 1 separately extends to one corresponding frame piece of the two adjacent frame pieces 4, 4a to form an extending arm 11. A toothed tongue portion 111 is formed on a distal end of the extending arm 11. The toothed tongue portion 111 can be plugged into the latching slot 42 of the frame pieces 4, 4a and the lower passage 41 to latch the toothed tongue portion 111 on an inner wall of the latching slot 42 and the lower passage 41 thereby fixing the L shaped member 1 at the end side of the frame piece 4, 4a. The L shaped member 1 further includes a bending portion 13 defining a mortise 12 extending to the extending arm 11 (as shown in FIG. 7).

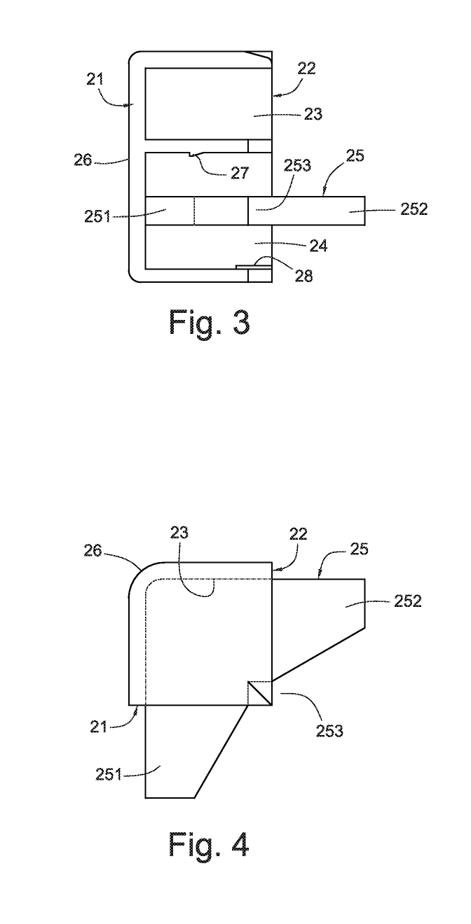

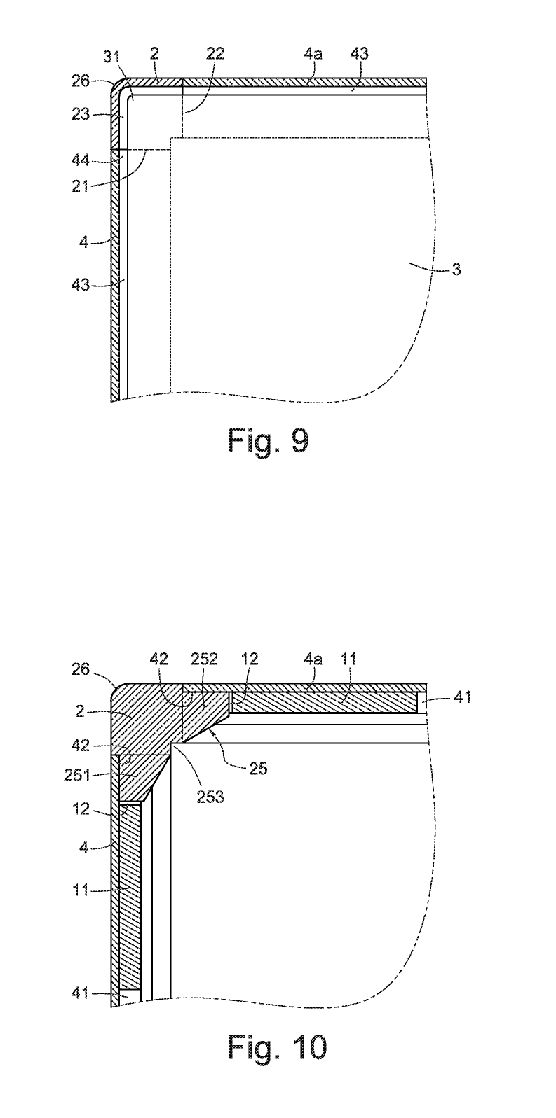

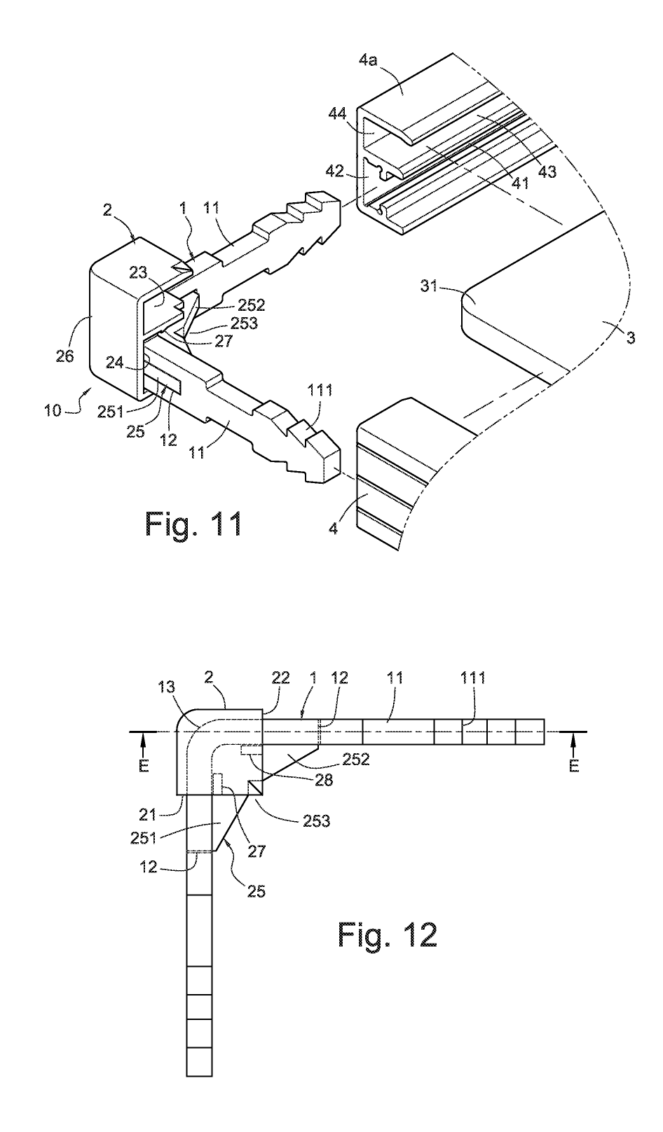

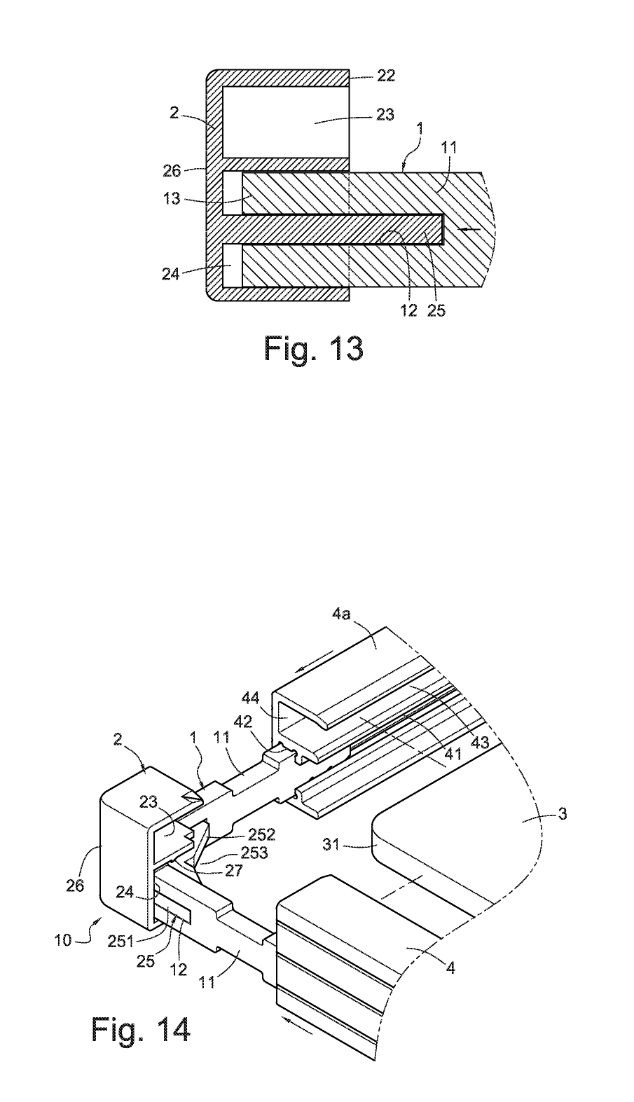

The sheath 2 can be comprised of metals such as aluminum, iron, or copper, and can be rectangular (as shown in FIGS. 1-4). The sheath 2 includes two joint surfaces 21, 22 for abutting end sides of the frame pieces 4, 4a. The two joint surfaces 21, 22 can be perpendicular to each other. The sheath 2 defines an upper receiving space 23 and a lower receiving space 24 exposed from the joint surfaces 21, 22. The upper receiving space 23 and the lower receiving space 24 are configured for receiving a corner 31 of the solar panel 3 (as shown in FIGS. 7, and 9) and the bending portion 13, respectively. Referring to FIGS. 5, 6, 8, 10-13, the sheath 2 further includes a tenon 25 can be plugged into the mortise 12 is formed in the lower receiving space. The tenon 25 and a main body of the sheath 10 are formed into a unitary piece. The tenon 25 is substantially V shaped and has a first end 251 and a second end 252. The first end 251 and the second end 252 can be separately plugged into the mortise 12 of the L shaped member 1. The tenon 25 further defines a notch 253 between the first end 251 and the second end 252 (as shown in FIG. 10) and at on a joint of the two adjacent frame pieces 4, 4a. The notch 253 can prevent the tenon 25 masking the sunlight irradiated onto the corner 31. Therefore, the sheath 2 can join the L shaped member 1 and the solar panel 3.

In addition, the sheath 2 has an outer fillet surface 26 (as shown in FIGS. 1-6) at a corner of the frame 40. The fillet surface 26 is symmetrical relative to an angle bisector surface of the joint surfaces 21, 22. Latching protrusions 27 and 28 are formed on a top and bottom portion of an inner wall of the lower receiving space 24, respectively. The latching protrusions 27 and 28 are configured for latching the bending portion 13 in the lower receiving space 24. The distance between the latching protrusions 27, 28 and the inner walls of the lower receiving space 24 can immediately allow the bending portion 13 of the L shaped member 1 being received therein. In the present embodiment, the latching protrusion 27 is formed on the top of the inner wall of the lower receiving space 24 to extend downwardly, and the latching protrusion 28 is formed on the bottom of the inner wall of the lower receiving space 24 to extend upwardly. As such, the L shaped member 1 can be latched in the lower receiving space 24.

In addition, the sheath 2 can also be comprised of plastic (as shown in FIGS. 1-4) such that the sheath 2 has elastic ability. As such, when the bending portion 13 is received in the lower receiving space 24, the inner wall of the lower receiving space 24 is expanded due to the pressure that the bending portion 13 applies to the latching protrusions 27, 28. Thus, the bending portion 13 easily passes the latching protrusions 27, 28.

The above description discloses the structure of the corner joint 10, and the corner joint 10 will be further described as follows.

The bending portion 13 of the L shaped member 1 is held in the lower receiving space 24 of the sheath 2 (as shown in FIGS. 1, 11-13) such that the first and second ends 251, 252 of the tenon 25 are separately plugged into the mortise 12 of the L shaped member 1. The L shaped member 1 is latched in the lower receiving space 24 by the latching protrusions 27, 28.

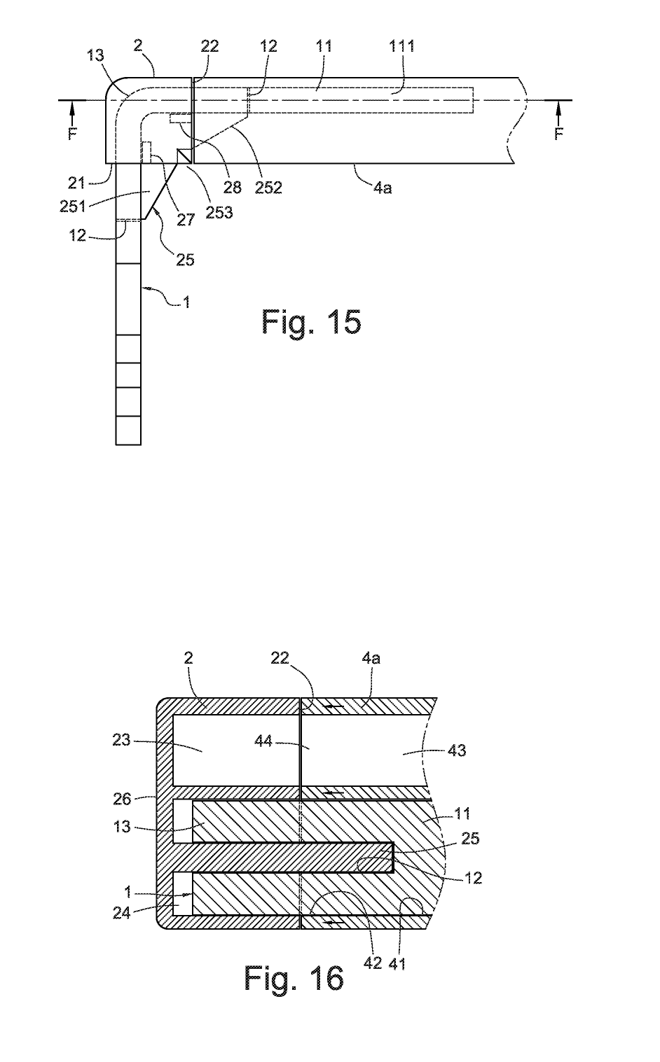

The extending arms 11 at two ends of the L shaped member 1 are plugged into and concealed in the latching slot 42 and the lower passage 41 of the frame piece 4 and the frame piece 4a, respectively (as shown in FIGS. 10, 14-16). Also, the L shaped member 1 is latched at end sides of the frame pieces 4, 4a by the toothed tongue portion 111 thereby improving the assembling stability of the L shaped member 1, and the frame pieces 4, 4a. In addition, the first end 251 and the second end 252 of the tenon 25 can also be received and concealed in the latching slot 42 at end sides of the frame pieces 4, 4a. Thus, better latching effect is obtained. The upper receiving space 23 of the sheath 2 is communicated with the opening 44 and the upper slot 43. Therefore, the sheath 2 is disposed between the two perpendicularly arranged frame pieces 4, 4a, and is exposed form the frame 40. The outer fillet surface 26 of the sheath 2 is at a corner of the frame 40.

The corner 31 of the solar panel 3 is received in the upper receiving space 23 of the sheath 2 (as shown in FIGS. 7 and 9). In addition, because the upper receiving space 23 are separately communicated to the upper slot 43 of the frame pieces 4, 4a, thus an edge portion of the solar panel 3 can be separately received in the upper slot 43 of the frame pieces 4, 4a (as shown in FIG. 8), so that A complete frame 40 is assembled around the solar panel 3 (as shown in FIGS. 5 and 6).

The corner joint 10 of the present embodiment has following advantages.

1. When the corner joint 10 is assembled with the frame pieces 4, 4a, there is no joint or screws exposed and thus the aesthetic effect is improved.

2. The frame pieces 4, 4a and the corner joint 10 are assembled to constitute the frame 40, and the sheath 2 and the outer fillet surface 26 of the sheath 2 are at a corner of the frame 40 for protecting the joint of the frame pieces 4, 4a. Thus, the chance of the frame 40 hurting operators can be effectively avoided. In other words, the operators are protected from being hurt.

3. The sheath and the L shaped member can be separately molded thereby reducing the manufacturing complexity thereof. Therefore, the manufacturing cost of the present corner joint is low.

4. The sheath 2 is joined on an outside of the L shaped member 1 and between the frame pieces 4, 4a by the tenon 25 such that the sliding offset of the sheath 2, the L shaped member 1, the frame pieces 4, 4a and the solar panel 3 is reduced. Thus, the soundness of the frame 40 is improved. Also, the safety and the practicality of the frame 40 are improved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A corner joint of a frame for fixing a solar panel, the frame comprising two adjacent frame pieces, the corner joint being disposed between the two adjacent frame pieces, the corner joint comprising:
an L shaped member, two ends thereof separately extending to one corresponding frame piece of the two adjacent frame pieces to form an extending arm plugged into a latching slot defined in an end of the corresponding frame piece, the L shaped member further comprising a bending portion defining a mortise extending to the extending arm; and
a sheath, comprising two adjacent joint surfaces for abutting the two adjacent frame pieces, the sheath defining an upper receiving space and a lower receiving space therein, the upper receiving space and the lower receiving space being separately exposed from the joint surfaces, the upper receiving space and the lower receiving space being configured for receiving a corner of the solar panel and the bending portion, respectively, the sheath further comprising a tenon capable of being plugged into the mortise and received in the latching slot such that the sheath joins the L shaped member and the solar panel.

2. The corner joint of claim 1, wherein the sheath is comprised of plastic or metals.

3. The corner joint of claim 1, wherein the sheath is rectangular.

4. The corner joint of claim 1, wherein the sheath comprises an outer fillet surface symmetrical relative to an angle bisector surface of the two adjacent joint surfaces.

5. The corner joint of claim 1, wherein the two adjacent joint surfaces are perpendicular to each other.

6. The corner joint of claim 1, wherein a latching protrusion is formed on a top or bottom portion of an inner wall of the lower receiving space for latching the bending portion.

7. The corner joint of claim 1, wherein the tenon defines a notch at a joint of the two adjacent frame pieces.
